(19) United States
(12) Patent Application Publication
(10) Pub. No.: US 2015/0379857 A1
(43) Pub. Date: Dec. 31, 2015

(54) Monitoring Apparatus and Related Methods

(71) Applicant: Secure Care Products, LLC, Concord, NH (US)

(72) Inventors: Albert Larose, Dracut, MA (US); Douglas A. Richard, Tilton, NH (US); Matthew Cammack, Weare, NH (US); Christopher D. Stevens, Belmont, NH (US); Michael Singer, Concord, NH (US); Sam Corliss, Penacook, NH (US); Vijaya Kodali, Nashua, NH (US); Ray Scott, Webster, NH (US); Jon Dixon, Nashua, NH (US)

(21) Appl. No.: 14/314,491

(22) Filed: Jun. 25, 2014

(51) Int. Cl. G08B 21/18

(52) U.S. Cl. CPC G08B 21/185

(57) ABSTRACT

A monitoring apparatus and related methods is disclosed. The monitoring apparatus includes a banding structure. The banding structure is connectable to a housing. At least one non-wired, conductive element is connected to the banding structure and positioned along a length of the banding structure, wherein the at least one non-wired, conductive element is connected to form a circuit through the housing. A cut-band detection element is in communication with the circuit, wherein the cut-band detection element detects a break in the circuit.

### FIELD OF THE DISCLOSURE

The present disclosure is generally related to monitoring objects and more particularly is related to a monitoring apparatus and related methods.

### BACKGROUND OF THE DISCLOSURE

It is often necessary to monitor the activity of a person, animal, or object to ensure that the person, animal, or object is not subject to dangerous conditions. For example, healthcare facilities often monitor patients and/or residents of these facilities to ensure that they are within a specific location inside the facility or that they are acting in accordance with rules of the facility. In nursing homes, elderly residents are often monitored to ensure that they do not leave the nursing home premises. Without monitoring, these elderly residents may exit the nursing home and be subject to dangerous environmental conditions, which could lead to injury and even fatalities. Some systems are currently available to allow for monitoring of living beings and objects, but these systems are easy to sabotage and obviate.

For example, some conventional monitoring systems may include a wristband that can easily be cut or slipped off a user's wrist, which may go unnoticed by the monitoring systems. Thus, the user could go unmonitored for a substantial period of time before any unusual activity is noticed. Furthermore, conventional monitoring systems may only be capable of monitoring a user in one aspect, such as based on the user's proximity to a sensor, the user's movement, or the status of a wristband, to name a few. This means that there are large functionality gaps in the conventional systems, which can limit the usefulness of the system overall.

Some types of monitoring systems may monitor a user's location within a structure, such as a hospital or medical facility. Determining the location of a person or object in a timely and accurate manner may save money and time, but may also minimize the risk of injury or a security breach. For example, in today's hospitals and medical facilities locating systems are used to determine the approximate location of infants and the elderly. When a baby is born, a security tag is attached to their leg to prevent abduction of the infant during their stay at the hospital. When an abductor attempts to remove the infant from the hospital, proximity sensors may signal an alarm to sound. Similar systems are used in nursing homes to prevent residents with mental disorders from exiting the building without authorization. Many industries do not have locating systems in use, due to their expense and inconvenience in using them. For example, malls and shopping centers commonly only provide stationary maps with an indication of where the map is located relative to the building.

These current systems may include a real-time locating system (RTLS), which may facilitate locating an object within a building. These systems operate by utilizing a number of different techniques, including sending pinging signals, RFID technology, ultrasound and other conventional locating technologies. Similarly, GPS may be used for locating objects in certain instances. However, these current systems are expensive and may only work under specific conditions. For example, GPS may fail to work when the satellite signal is lost, such as when the GPS receiver is within a tunnel. Likewise, the proximity sensors used in hospitals may only indicate the presence of a security tag, and fail to provide any further information.

Thus, a heretofore unaddressed need exists in the industry to address the aforementioned deficiencies and inadequacies.

### SUMMARY OF THE DISCLOSURE

Embodiments of the present disclosure provide a monitoring apparatus and related methods. Briefly described, in architecture, one embodiment of the apparatus, among others, can be implemented as follows. The monitoring apparatus includes a banding structure. The banding structure is connectable to a housing. At least one non-wired, conductive element is connected to the banding structure and positioned along a length of the banding structure, wherein the at least one non-wired, conductive element is connected to form a circuit through the housing. A cut-band detection element is in communication with the circuit, wherein the cut-band detection element detects a break in the circuit.

The present disclosure can also be viewed as an appendage-worn monitoring apparatus. Briefly described, in architecture, one embodiment of the apparatus, among others, can be implemented as follows. The appendage-worn monitoring apparatus includes a banding structure having a plurality of holes formed along a length thereof. The banding structure is connectable to a housing through at least one locking pathways positioned on opposing sides of the housing. At least one non-wired, conductive element is connected to the banding structure and positioned along the length of the banding structure. A conductive interface is positioned through a sidewall of the housing, wherein a circuit is formed through the housing using the at least one non-wired, conductive element and the conductive interface. A cut-band detection element is in communication with the circuit, wherein the cut-band detection element detects a break in the circuit.

The present disclosure can also be viewed as providing a method of monitoring using an appendage-worn monitoring apparatus. In this regard, one embodiment of such a method, among others, can be broadly summarized by the following steps: positioning a banding structure fully around an appendage of a living being or objects, wherein the banding structure includes at least one non-wired, conductive element connected to the banding structure and positioned along a length of the banding structure, wherein the at least one non-wired, conductive element is connected to a housing to form a circuit; detecting at least one alert with the circuit, detection of the at least one alert comprising detecting a break in the circuit with a cut-band detection element in communication with the circuit.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is an illustration of a monitoring apparatus, in accordance with a first exemplary embodiment of the present disclosure.

FIG. 2 is a longitudinal cross-sectional illustration of the apparatus of FIG. 1, in accordance with the first exemplary embodiment of the present disclosure.

FIG. 3 is a cross-sectional illustration of the apparatus of FIG. 1, in accordance with the first exemplary embodiment of the present disclosure.

FIG. 4 is a plan view illustration of a monitoring apparatus, in accordance with the first exemplary embodiment of the present disclosure.

FIG. 5 is a cross-sectional view illustration of a monitoring apparatus, in accordance with the first exemplary embodiment of the present disclosure.

FIG. 6 is a plan view illustration of a monitoring apparatus, in accordance with a second exemplary embodiment of the present disclosure.

FIG. 7 is a flowchart illustrating a method of monitoring using an appendage-worn monitoring apparatus, in accordance with a third exemplary embodiment of the disclosure.

### DETAILED DESCRIPTION

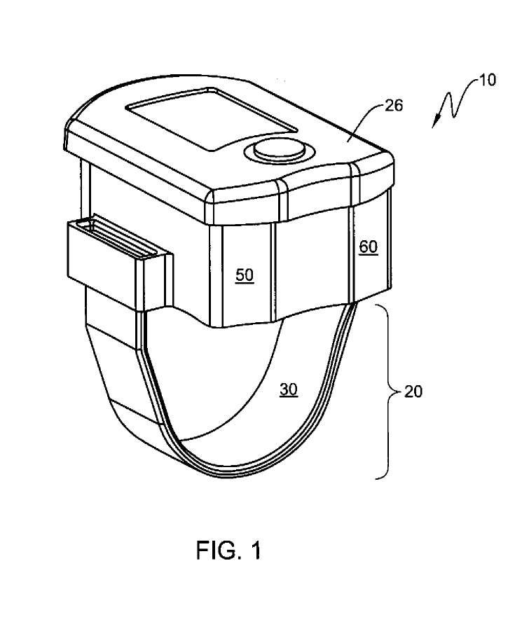

FIG. 1 is an illustration of a monitoring apparatus 10, in accordance with a first exemplary embodiment of the present disclosure. The monitoring apparatus 10, which may be referred to herein simply as the apparatus 10, includes a banding structure 20. The banding structure 20 is connectable to a housing 26. At least one non-wired, conductive element 30 is connected to the banding structure 20 and positioned along a length of the banding structure 20. The at least one non-wired, conductive element 30 is connected through the housing 26 to form a circuit. A cut-band detection element 50 is in communication with the circuit, wherein the cut-band detection element 50 detects a break in the circuit. A capacitance detection element 60 is in communication with the circuit, wherein the capacitance detection element 60 detects a change in a capacitance level within the circuit.

The apparatus 10 may be used in any number or type of industries where it may be desirable to monitor a living being, such as a human being or an animal, or any object or entity. For example, the apparatus 10 may be used within the healthcare industry in hospitals, doctors' offices, medical facilities, long-term treatment facilities, nursing homes, mental health centers, and any other type of health care establishment. Within the healthcare industry, it is often necessary to monitor a patient to make sure that they are not in danger to themselves, or to determine that they are located in (or not located in) a specific location. For example, it is often necessary to monitor elderly residents in nursing homes to ensure that they're not in danger and to ensure that they stay within the nursing home premises. Successful monitoring of these elderly residents may prevent injuries by monitoring the elderly residents and intercepting them before they are in dangerous locations, such as outside the nursing home facility.

Banding structure 20 may be constructed from any type of material or materials, including rubber, plastic, and other synthetic or natural materials. The banding structure 20 may include any number or type of materials in any combination. Preferably, the banding structure is constructed from a material that is capable of being worn close to the skin of a living being, such that it does not cause injury or substantial irritation. The non-wired, conductive elements connected to the banding structure 20 may be constructed from any various types of non-wired, conductive material and materials, including conductive inks positioned on the banding structure 20, conductive cloth or fabric formed in the banding structure 20, and conductive foam formed in the banding structure 20. Other conductive materials, such as plated circuits, and conductive paints may also be used within the banding structure 20. The banding structure 20 may be secured around an appendage of a living being. The banding structure 20 may be secured around the wrist or ankle of a human being, but it may also be secured around the leg, arm, neck, or other body part, of any living being, including any dog, cat or other animal or objects. In accordance with this disclosure, the apparatus 10 is discussed with regards to the banding structure 20 being secured on an appendage of a living being. However, the banding structure 20 may be affixed to or secured on any other object, item, component or body part of any device, structure or entity, all of which are considered within the scope of the present disclosure.

The non-wired, conductive element 30 connected to or formed in the banding structure 20 may include conductive inks positioned on the banding structure 20, conductive cloth or fabric formed in the banding structure 20, and conductive foam formed in the banding structure 20. It is noted that conductive cloth or fabric may be constructed from individual conductive threads, which are not considered conductive wires within this disclosure. These conductive materials may be formed conveniently with the banding structure 20 such that they do not interfere with the ease of use and ergonomic nature of the banding structure 20 when it is positioned about an appendage of the user. The non-wired, conductive element 30 may be formed within the banding structure 20, such as within an internal layer of the banding structure 20, along an exterior surface of the banding structure 20, or any combination thereof. For non-wired, example, the non-wired, conductive element 30 may be formed along an interior of the banding structure 20, whereby holes within the banding structure 20 expose portions of the non-wired, conductive element 30 for contact with the housing 26, such as a conductive prong of the housing 26 that could be sized to fit within the holes within the banding structure 20 or outside of the holes.

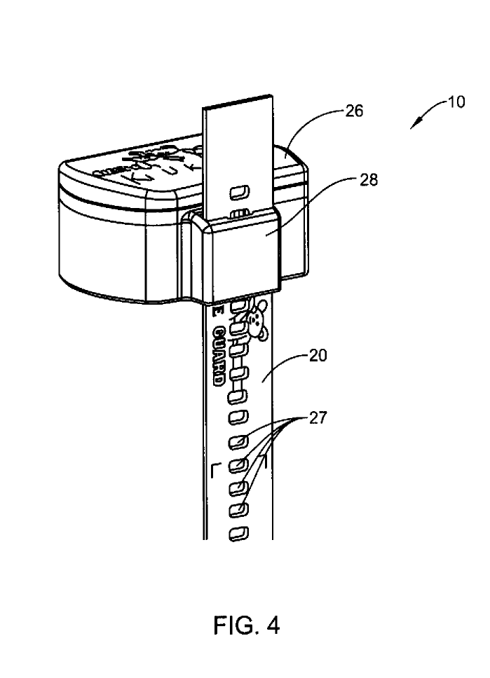

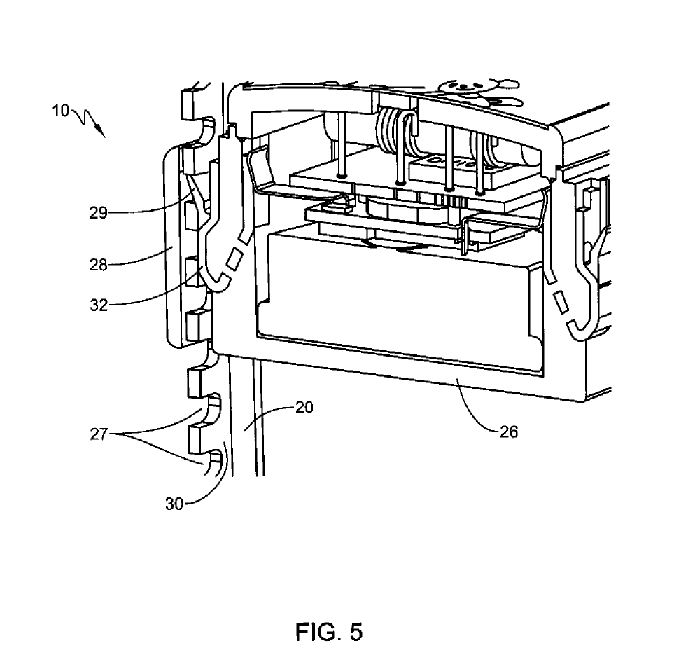

In one example, when conductive cloth is used as the non-wired, conductive element 30, either with or as the banding structure 20, the conductive cloth may include a woven cloth having an electrically conductive coating, such as a nylon tricot knit material having a conductive coating. The non-wired, conductive element 30, whether a conductive ink, a conductive cloth, or a conductive foam, may be positioned on an external surface of the banding structure 20, or it may be positioned internally within the banding structure 20. As discussed further relative to FIGS. 4-5, when the banding structure 20 includes a plurality of holes formed along the length of the banding structure 20 and through a thickness of the banding structure 20, the non-wired, conductive element 30 may be positioned at least partially along a sidewall of at least a portion of the plurality of holes.

It is preferable for the banding structure 20 to be substantially removal-resistant to a wearer or to an object to which the banding structure 20 is affixed. In other words, the banding structure 20 may be substantially resistant to cutting, breaking, or removing by any other means, such as sliding it over the appendage. This is a desirable property of the banding structure 20, since the apparatus 10 is substantially limited in its ability to monitor a user when it is not secured on the user. The banding structure 20 itself, as well as other components, as discussed herein, may hinder intentional and purposeful attempts to remove the banding structure 20 from the appendage to which it is attached. However, the banding structure 20 may be durable and have a composition that is resistant to unintended damage that could result in the banding structure 20 being removed from the appendage.

One of the removal resistant aspects of the apparatus 10 is generally provided by including cut-resistant materials within the banding structure 20. For example, a cut-resistant wire or a plurality of cut-resistant wires may be included within the banding structure 20. The wires do not need to be in an electrical circuit. In another example, a cloth that is cut-resistant may be included with the banding structure 20. The cloth may or may not be conductive or included in the circuit. For example, the cloth may be a conductive cloth that is used to both preventing cutting of the band and with the circuit for capacitive sensing.

When a wire is used as a cut-resistant material, it may include at least one-wire which is affixed to the banding structure, or more commonly, may be embedded within the banding structure 20 such that the banding structure 20 encompasses substantially all portions of the wire or wires. The wires may be constructed from any material, such as any metal, including and metallic compound or pure metal. In one example, the wires are constructed from a cut-resistant stainless steel, which has a high density. The high density in stainless steel, or any other high-density metal, may prevent the at least one wire from being severed, cut or broken, such as with scissors, pliers, and/or wire-cutters. In accordance with this disclosure, it is noted that a substantially cut-resistant material may include any material that is capable of resisting being cut or severed by a tool.

The non-wired, conductive element 30 may be positioned along the length of the banding structure 20, as is shown in FIG. 1. The non-wired, conductive element 30 may run along the complete length of the banding structure such that substantially all cross-sectional segments of the banding structure 20 have a portion of the non-wired, conductive element 30 embedded therein or formed thereon. The non-wired, conductive element 30 may be connected at either ends of the banding structure 20 with the housing 26, which may include any fastener or device that is capable of fastening a first end of the banding structure 20 to a second end of the banding structure 20. Commonly, the housing 26 may also contain various components of the apparatus 10, including the cut-band detection element 50, the capacitance detection element 60, and a transmitter for transmission of data detected by the cut-band detection element 50 and the capacitance detection element 60. The ends of the non-wired, conductive element 30 may be connected together to form a circuit through the banding structure 20 and at least a portion of the housing 26. The circuit may also include any additional electronic components that are connected by non-wired, conductive element 30 through which electric current may flow. The circuit is preferably a closed circuit, wherein when the non-wired, conductive element 30 is severed, the circuit becomes open, which may be used to signal an alarm or transmit a signal to another component, as is discussed further below.

The apparatus 10 includes a cut-band detection element 50 and a capacitance detection element 60, both of which are in communication with the circuit. Commonly, as is shown in FIG. 1, the cut-band detection element 50 and the capacitance detection element 60 are included with the transmitter within the housing 26, such as by being formed integral with the circuitry of the transmitter, such that detection of cut-band and capacitance is achieved within the transmitter. In FIG. 1, the cut-band detection element 50 and the capacitance detection element 60 are illustrated as being within the housing 26 and in direct communication with the circuit, however, these elements may also be in any other form of communication with the circuit, such as wired, wireless or integral communication. For example, the cut-band detection element 50 and capacitance detection element 60 may be integral with the circuit and the non-wired, conductive element 30. Alternatively, the cut-band detection element 50 and the capacitance detection element 60 may be located remote from the circuit and be capable of communicating with the circuit with any number of wired or wireless communication mediums, or any combination thereof. The cut-band detection element 50 may also be a trace, such as an ink or paint trace, or any other type of conductive circuit, all of which are considered within the scope of the present disclosure.

The cut-band detection element 50 may detect when the non-wired, conductive element 30 is severed or broken, such that the circuit transforms from a closed circuit where the non-wired, conductive element 30 are not broken, to an open circuit where the non-wired, conductive element 30 is broken. It is further noted that any additional number of conductive features may be included with the non-wired, conductive element 30, and breaking or severing any of the conductive features may result in activation of the cut-band detection element 50.

The capacitance detection element 60 may work alone or in combination with the cut-band detection element 50. The capacitance detection element 60 may continuously or intermittingly monitor a capacitance level within the circuit and/or monitor a comparative stability of the capacitance measurement. The capacitance level within the circuit is influenced by the appendage or other bodily flesh that the banding structure 20 is secured to. Accordingly, different capacitance level may be detected when the banding material 20 is proximate to the appendage than when the banding structure 20 is removed from the appendage. Thus, by monitoring the capacitance level within the circuit, the capacitance detection element 60 can accurately determine when a change in the capacitance level occurs, which can be reasoned to correspond to when the banding structure 20 is not secured to the appendage, such as if the banding structure 20 should be removed or loosened from the body appendage enough to correspond to it being excessively loose. It is noted that the capacitance detection element 60 or the non-wired, conductive element 30, or both, may measure or detect a change in capacitance. Similarly, the circuit formed from the non-wired, conductive element 30, which could be a trace circuit, when broken, and the capacitive detection element 60 may also be in one circuit.

As can be understood by one skilled in the art based on this disclosure, the apparatus 10 may provide multiple levels of monitoring functionality. These includes the removal-resistant properties of the apparatus 10, since the banding structure 20 and/or the non-wired, conductive element 30 are substantially resistant to being cut, broken or severed. Therefore, the apparatus 10 affords at least a first level of functionality by limiting a user's ability to remove the banding structure 20 from a monitoring position. Additionally, the apparatus 10 via the circuit and the broken-circuit detection element 50 is capable of determining when the circuit is broken or not broken. Accordingly, when a closed (unbroken) circuit suddenly becomes an open circuit (broken), which may occur when non-wired, conductive element 30 is broken or severed, the broken-circuit detection element 50 may indicate that removal of the banding structure is occurring or has occurred. Based on this determination, a proper response to the situation may be enacted, which may include manually checking the physical status of the banding structure 20 and the non-wired, conductive element 30, replacing the banding structure 20, and/or tracking down the user from which the banding structure 20 was removed.

The next level of functionality may be provided by the circuit and the capacitance detection element 60, wherein the apparatus 10 may monitor removal of the banding structure 20 without breaking or severing the non-wired, conductive element 30 in the circuit. For example, this may occur when a user is being monitored by the apparatus 10 attempts to remove the banding structure 20 from his or her wrist. The banding structure 20 may be difficult to remove due to its tight fit around the user's wrist, and may also be difficult to cut off, due to the substantially cut-resistant nature of the banding structure 20. However, the user may be able to manipulate the banding structure 20 in a way where it can be slipped over the user's hand or foot (when the banding structure 20 is on a user's ankle). Accordingly, the capacitance level within the circuit may be substantially constant while the banding structure 20 is secured on the appendage, but as soon as the banding structure 20 is removed from a location proximate to the appendage, a change in capacitance will occur. The capacitance detection element 60 may determine when this change in capacitance occurs to provide an alert or notification that the banding structure 20 has been removed. Based on this determination, a proper response to the situation may be enacted, which may include manually checking the physical status of the banding structure 20, the non-wired, conductive element 30 and/or the circuit, re-securing the banding structure 20 to a user's appendage, and/or tracking down the user from which the banding structure 20 was removed.

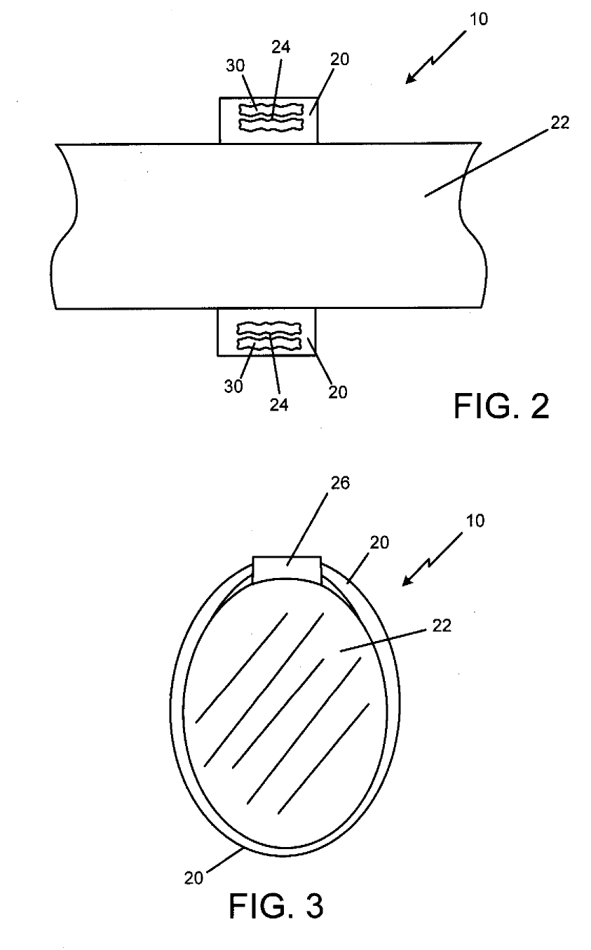

FIG. 2 is a longitudinal cross-sectional illustration of the apparatus 10 of FIG. 1, in accordance with the first exemplary embodiment of the present disclosure. As can be seen in FIG. 2, the banding structure 20 is secured on an appendage 22 of a living being. The banding structure 20 may be secured in a close proximity to the appendage 22, such that the banding structure 20 is incapable of being removed from the appendage 22 by slipping it over an end of the appendage 22. FIG. 2 depicts the non-wired, conductive element 30 as being connected to the banding structure 20 on an external surface of the banding structure 20. A substantially non-stretchable scrim material 24 may be integral with the banding structure 20 as well. The substantially non-stretchable scrim material 24 may prevent the banding structure 20 from being stretched, which may loosen it from a secured position on the appendage 22.

FIG. 3 is a cross-sectional illustration of the apparatus 10 of FIG. 1, in accordance with the first exemplary embodiment of the present disclosure. As can be seen, the banding structure 20 is secured around an appendage 22 with the housing 26. The housing 26 connects a first end of the banding structure 20 to a second end of the banding structure 20, thereby forming the banding structure 20 into a loop shape, which fully encircles the appendage 22. The housing 26 may include any type of clasping device or fastener to retain the ends of the banding structure 20, and may preferable that the housing 26 is difficult to remove manually, i.e., without specialized tools. For example, the housing 26 may include a fastener with hidden prongs to engage the banding structure 20, a fastener with a living hinge, wherein one side of the fastener connects with a second side of the fastener around the two ends of the banding structure 20, or another type of fastener. The housing 26 may hold the ends of the banding structure 20 together to connect the non-wired, conductive element 30 to form the circuit, and may also include additional electronic components that connect to the circuit. Additionally, the housing 26 may hold the banding structure 20 in the loop shape about the appendage with sufficient durability, thereby retaining the banding structure 20 for use. Housing 26 may enable easy cinching or tightening of band structure 20.

FIG. 4 is a plan view illustration of a monitoring apparatus 10, in accordance with the first exemplary embodiment of the present disclosure. As can be seen in FIG. 4, the banding structure 20 includes a plurality of holes 27 formed through the banding structure 20. The holes 27 may be positioned along any length of the banding structure 27. The banding structure 20 may be connected to the housing 26 by slipping the end of the banding structure 20 in to a fastener portion of the housing 26. The fastener portion 28 may include a pathway that the banding structure 20 may be inserted into, such that the engagement of the banding structure 20 to the housing 26 may be substantially covered by the fastener portion 28. Coverage of the engagement may assist with preventing interference with or disablement of the engagement.

FIG. 5 is a cross-sectional view illustration of a monitoring apparatus 10, in accordance with the first exemplary embodiment of the present disclosure. FIG. 5 illustrates the engagement of the banding structure 20 with the housing 26, including a depiction of both a mechanical engagement and an electrical engagement therebetween. The mechanical engagement may be facilitated, at least in part, with the prong 29 of the housing 26 engaging with the hole 27 of the banding structure 20 in a position interior of the fastener portion 28. In this position, the banding structure 20 may be prevented from being removed from the fastener portion 28 in one direction by the prong 29, yet can be moved in the other direction, based on the angle of the prong 29. Accordingly, once the banding structure 20 is positioned around a user's appendage, it may be further tightened but it may not be loosened. The fastener portion 28 may prevent moving the banding structure 20 out of the engaged or locked position with the prong 29.

The banding structure 20 may also be electrically engaged with the housing 26 using the non-wired, conductive element 30 within the banding structure 20 and at least one conductive interface 32 positioned to electrically connect the banding structure 20 with electrical components interior of the housing 26, such as a circuit board, processor, and various detection elements. The conductive interface 32 may be positioned through a wall of the housing 26. The housing may be formed from a non-conductive material, such as plastic, such that the conductive interface 32 provides an electrical pathway through the non-conductive housing 26. As can be seen in FIG. 5, the conductive interface 32 located through a wall of the housing 26 is positioned between the banding structure 20 and interior of the housing 26, where the cut-band detection element and the capacitance detection element are located. The conductive interface 32 may be sized such that the banding structure 20 is movable past it. The conductive interface may include the prong 29 or may be exclusive of the prong 29.

Depending on the position of the non-wired, conductive element 30 on or in the banding structure 20, the prong 29 may be a portion of the circuit. For example, when the non-wired, conductive element 30 is positioned interior of the banding structure 20, portions of the non-wired, conductive element 30 may be exposed on the sidewalls of the holes 27. When this configuration is present, the tips of the prongs 29 may contact the exposed non-wired, conductive element 30 to provide completion of the circuit. Thus, when the prong or prongs 29 extend into hole or holes 27 of the banding structure 20 when the banding structure 20 is in a locked position on the housing 26, the prongs 29 provide both mechanical and electrical engagement with the banding structure 20.

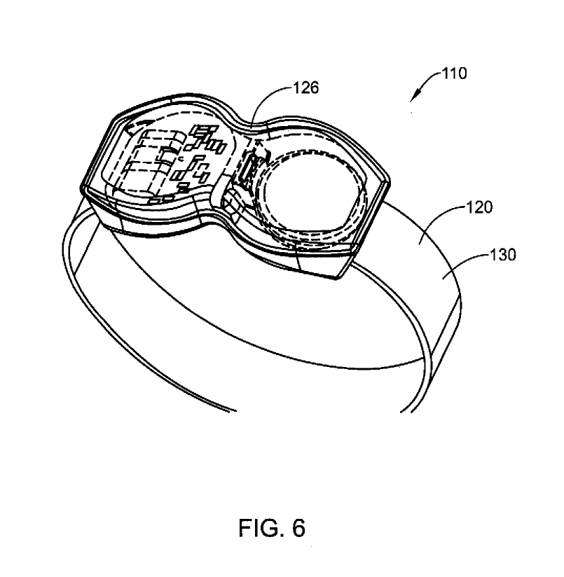

FIG. 6 is a plan view illustration of a monitoring apparatus 110, in accordance with a second exemplary embodiment of the present disclosure. The monitoring apparatus 110 of the second exemplary embodiment may include the general structure and functioning of the apparatus 10 of the first exemplary embodiment. As is shown in FIG. 6, the banding structure 120 may include a structure without holes, whereby the banding structure 120 is engagable with the housing 126 using a fastening system that does not require holes. For example, the banding structure may include a nylon woven knit with a conductive coating that is clamped to the housing 126 when it is locked thereto. Further, the banding structure 120 may be connected to the housing 126 on non-opposing sides of the housing 126, such as along the bottom of the housing 126 on the opposing edges thereof. All components, functions, and features disclosed relative to the first exemplary embodiment may also be included within the monitoring apparatus 110 of the second exemplary embodiment.

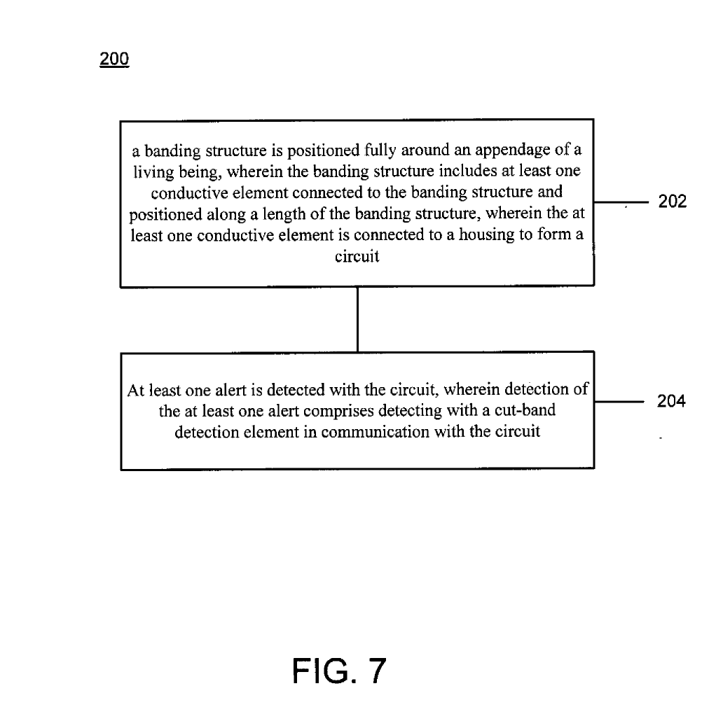

FIG. 7 is a flowchart 200 illustrating a method of monitoring using an appendage-worn monitoring apparatus, in accordance with a third exemplary embodiment of the disclosure. It should be noted that any process descriptions or blocks in flow charts should be understood as representing modules, segments, portions of code, or steps that include one or more instructions for implementing specific logical functions in the process, and alternate implementations are included within the scope of the present disclosure in which functions may be executed out of order from that shown or discussed, including substantially concurrently or in reverse order, depending on the functionality involved, as would be understood by those reasonably skilled in the art of the present disclosure.

As is shown by block 202, a banding structure is positioned fully around an appendage of a living being, wherein the banding structure includes at least one non-wired, conductive element connected to the banding structure and positioned along a length of the banding structure, wherein the at least one non-wired, conductive element is connected to a housing to form a circuit. At least one alert is detected with the circuit, wherein detection of the at least one alert comprises detecting with a cut-band detection element in communication with the circuit (block 204).

It should be emphasized that the above-described embodiments of the present disclosure, particularly, any “preferred” embodiments, are merely possible examples of implementations, merely set forth for a clear understanding of the principles of the disclosure. Many variations and modifications may be made to the above-described embodiments of the disclosure without departing substantially from the spirit and principles of the disclosure. All such modifications and variations are intended to be included herein within the scope of this disclosure and the present disclosure and protected by the following claims.

What is claimed is:

1. A monitoring apparatus comprising:
a banding structure;
a housing, wherein the banding structure is connectable to the housing;
at least one non-wired, conductive element connected to the banding structure and positioned along a length of the banding structure, wherein the at least one non-wired, conductive element is connected to form a circuit through the housing; and
a cut-band detection element in communication with the circuit, wherein the cut-band detection element detects a break in the circuit.

2. The monitoring apparatus of claim 1, further comprising a substantially non-stretchable scrim material integral with the banding structure.

3. The monitoring apparatus of claim 1, wherein the cut-band detection element further comprises a substantially cut resistant wire embedded within the banding structure.

4. The monitoring apparatus of claim 1, further comprising a transmission element positioned within the housing and in communication with the cut-band detection element, wherein the transmission element transmits a communication signal to a receiver when the break in the circuit is detected.

5. The monitoring apparatus of claim 1, wherein the housing is removably connectable to a first end of the banding structure and a second end of the banding structure.

6. The monitoring apparatus of claim 1, wherein the banding structure is positioned around an appendage of at least one of a living being and an object, wherein when positioned around an appendage of the living being, the appendage is at least one of a human wrist, a human arm, a human ankle and a human leg.

7. The monitoring apparatus of claim 6, wherein the appendage further comprises at least one of a human wrist, a human arm, a human ankle and a human leg.

8. The monitoring apparatus of claim 1, wherein the at least one non-wired, conductive element further comprises at least one of: a conductive ink positioned on the banding structure, a conductive cloth formed with the banding structure, and a conductive foam formed with the banding structure.

9. The monitoring apparatus of claim 8, wherein the conductive cloth further comprises a woven cloth having an electrically conductive coating.

10. The monitoring apparatus of claim 9, wherein the woven cloth having the electrically conductive coating further comprises a nylon knit having a conductive coating.

11. The monitoring apparatus of claim 8, wherein at least one of the conductive ink, the conductive cloth, and the conductive foam is positioned on an external surface of the banding structure.

12. The monitoring apparatus of claim 8, wherein at least one of the conductive cloth and the conductive foam is positioned internally within the banding structure.

13. The monitoring apparatus of claim 8, wherein the banding structure further comprises a plurality of holes formed along the length of the banding structure and through a thickness of the banding structure, wherein the at least one non-wired, conductive element is positioned at least partially along a sidewall of at least a portion of the plurality of holes.

14. The monitoring apparatus of claim 1, wherein the circuit further comprises at least one conductive interface positioned between the banding structure and the cut-band detection element, wherein the banding structure is movable past the at least one conductive interface.

15. The monitoring apparatus of claim 14, wherein the at least one conductive interface is positioned through a wall of the housing, wherein the housing is constructed from a non-conductive material.

16. The monitoring apparatus of claim 14, wherein the at least one conductive interface further comprises a locking prong, wherein the locking prong extends into at least one hole of the banding structure when the banding structure is in a locked position on the housing.

17. An appendage-worn monitoring apparatus comprising:
a banding structure having a plurality of holes formed along a length thereof;
a housing, wherein the banding structure is connectable to the housing through at least two locking pathways positioned on opposing sides of the housing;
at least one non-wired, conductive element connected to the banding structure and positioned along the length of the banding structure
a conductive interface positioned through a sidewall of the housing, wherein a circuit is formed through the housing using the at least one non-wired, conductive element and the conductive interface; and
a cut-band detection element in communication with the circuit, wherein the cut-band detection element detects a break in the circuit.

18. A method of monitoring using an appendage-worn monitoring apparatus, the method comprising the steps of:
positioning a banding structure fully around an appendage of a living being, wherein the banding structure includes at least one non-wired, conductive element connected to the banding structure and positioned along a length of the banding structure, wherein the at least one non-wired, conductive element is connected to a housing to form a circuit; and
detecting at least one alert with the circuit, detection of the at least one alert comprising detecting a break in the circuit with a cut-band detection element in communication with the circuit.

19. The method of claim 18, wherein the at least one non-wired, conductive element further comprises at least one of: a conductive ink positioned on the banding structure, a conductive cloth formed with the banding structure, and a conductive foam formed with the banding structure.

20. The method of claim 19, wherein the conductive cloth formed with the banding structure further comprises a woven nylon knit material having a conductive coating.
